(19) United States
(12) Patent Application Publication
(10) Pub. No.: US 2014/0129701 A1
(43) Pub. Date: May 8, 2014

(54) APPARATUS FOR MANAGING SHIP NETWORK

(71) Applicant: Electronics and Telecommunications Research Instit ute, Daejeon (KR)

(72) Inventors: Kwangil LEE, Daejeon (KR); Jun Hee PARK, Daejeon (KR)

(73) Assignee: Electronics and Telecommunications Research Instit ute, Daejeon (KR)

(21) Appl. No.: 14/070,345

(22) Filed: Nov. 1, 2013

(30) Foreign Application Priority Data
Nov. 2, 2012 (KR) 10-2012-0123789
Jul. 2, 2013 (KR) 10-2013-0076922

(51) Int. Cl. H04L 12/26

(52) U.S. Cl. CPC H04L 43/04
USPC 709/224

(57) ABSTRACT

An apparatus for stably controlling and managing a ship network, which is capable of analyzing traffic characteristics of various marine devices having different properties in the ship network covering the various marine devices and switch equipments, allocating suitably network resources to the marine devices depending on the analyzed traffic characteristics, and managing exceptional situations by monitoring the generation of the situations.

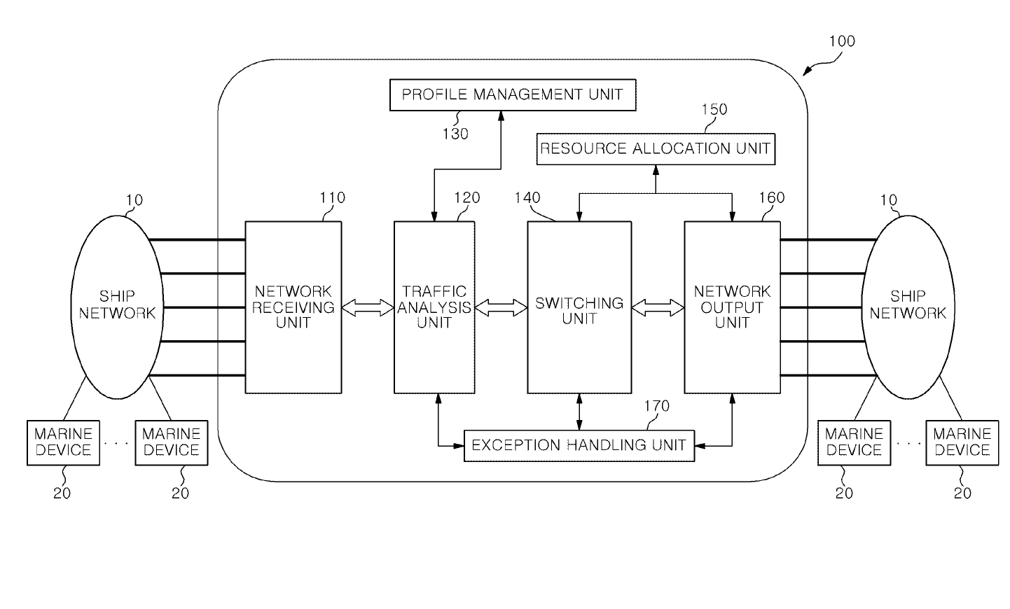

### RELATED APPLICATIONS

This application claims the benefit of Korean Patent Application Nos. 10-2012-0123789, filed on Nov. 2, 2012 and 10-2013-0076922, filed on Jul. 2, 2013, which is hereby incorporated by reference as if fully set forth herein.

### FIELD OF THE INVENTION

The present invention relates to a ship network managing system, and more particularly, to an apparatus for managing a ship network, which is adapted to stably control and manage the ship network composed of various marine devices and switch equipments.

### BACKGROUND OF THE INVENTION

As is well known, various marine devices are used in ships. In particular, in recent years, along with the introduction of electronic navigation systems (e-Navigation), various digital marine devices have increased. As a result, it is possible to provide a variety of information in addition to marine navigation information.

To meet the above needs, a ship network began to change from a serial network that provides only the limited bandwidth of existing narrow bandwidth to an Ethernet or an optical network that provides wide bandwidth.

However, the Ethernet or the optical network needs to construct one backbone network, which leads to an issue how to ensure information required by individual marine devices in a ship network.

For example, an Ethernet-based ship network is a shared network and hence exceptional situations may occur. As an example, if there occur errors in the marine devices or network resources are occupied by abnormal traffic due to viruses and worms, it may cause problems in the operation and management of remaining marine devices.

Therefore, there is a need to provide a ship network management apparatus for preventing the network resources from being monopolized and ensuring the quality of service required by the respective marine devices.

Further, unauthorized devices may be illegally connected to the ship network to generate traffic. In particular, when the unauthorized devices generate an abnormal traffic with a malicious purpose or exploit a long-term use service that requires large amounts of bandwidth, which incurs a problem of creating a threat to the stability of the ship network.

### SUMMARY OF THE INVENTION

In view of the above, the present invention provides an apparatus for stably controlling and managing a ship network, which is capable of analyzing traffic characteristics of various marine devices having different properties in the ship network covering the various marine devices and switch equipments, allocating suitably network resources to the marine devices depending on the analyzed traffic characteristics, and managing exceptional situations by monitoring the generation of the situations.

In accordance with an embodiment of the present invention, there is provided an apparatus for managing a ship network, the apparatus includes: a network receiving unit configured to receive traffic messages through the ship network from marine devices; a traffic analysis unit configured to parse the traffic messages being received to analyze traffic information; a profile management unit configured to profiles that include information on the characteristics of the traffic messages received through the network receiving unit; a switching unit configured to switch the traffic messages to their corresponding ports in accordance with destinations of the traffic messages; a resource allocation unit configured to allocate network resources to the ports as needed in compliance with the profiles; and a network output unit configured to send data corresponding to the traffic messages through the ports and the ship network.

Further, the apparatus may wherein the traffic information analyzed by the traffic analysis unit comprises identification information of transmitters for sending the traffic messages, identification information of receivers for receiving the traffic messages, protocol information of the traffic messages and type information of the traffic messages.

Further, the apparatus may wherein the traffic analysis unit is configured to: comprehend state information on the respective traffic messages that are identified on a basis of the traffic information; compare the traffic information, which is included in the profiles, that is previously stored in the profile management unit and the comprehended state information to determine whether to reach a threshold value; and perform a forwarding or drop the traffic messages depending on the determination result as to whether to reach the threshold value.

Further, the apparatus may wherein the profile management unit is configured to store and manage the profiles that include information about the marine devices and service information to be served in the respective marine devices.

Further, the apparatus may wherein the profile management unit is configured to manage the profiles by the transmitters for sending the traffic messages, the receivers for receiving the traffic messages, or the service information.

Further, the apparatus may wherein the profile management unit is configured to: configure the profiles pursuant to the traffic information that has been analyzed for a certain period of time through the traffic analysis unit; and create the profiles in accordance with inputs provided from a user or external inputs to manage the profiles.

Further, the apparatus may wherein the resource allocation unit is configured to allocate the network resources on the basis of the profile information, a user's input or an external input.

Further, the apparatus may further comprising an exception handling unit configured to perform an exception handling registration or deregistration function and an announcement function.

Further, the apparatus may wherein exception handling unit is configured to: register and deregister information on conditions of an exceptional situation and information on announcement devices; record the registered information in the traffic analysis unit for the storage thereof; receive event information that has been defined already from the traffic analysis unit; and notify an occurrence of the exceptional situations of the corresponding announcement devices when occurring the exceptional situations.

As set forth above, the embodiment of the present invention is designed to analyze traffic characteristics of the various marine devices having different properties in the ship network covering the various marine devices and switch equipments, allocate suitably network resources to the marine devices depending on the analyzed traffic characteristics, and managing exceptional situations by monitoring the generation of the situations.

Therefore, it is possible to implement the stable and reliable ship network through the stable control and management of the ship network.

### BRIEF DESCRIPTION OF THE DRAWINGS

The above and other objects and features of the present invention will become apparent from the following description of the embodiments given in conjunction with the accompanying drawings, in which:

Drawing is a block diagram of an apparatus for managing a ship network in accordance with an embodiment of the present invention.

### DETAILED DESCRIPTION OF THE EMBODIMENTS

Advantages and features of the invention and methods of accomplishing the same may be understood more readily by reference to the following detailed description of embodiments and the accompanying drawings. The invention may, however, be embodied in many different forms and should not be construed as being limited to the embodiments set forth herein. Rather, these embodiments are provided so that this disclosure will be thorough and complete and will fully convey the concept of the invention to those skilled in the art, and the invention will only be defined by the appended claims. Like reference numerals refer to like elements throughout the specification.

In the following description of the present invention, if the detailed description of the already known structure and operation may confuse the subject matter of the present invention, the detailed description thereof will be omitted. The following terms are terminologies defined by considering functions in the embodiments of the present invention and may be changed operators intend for the invention and practice. Hence, the terms need to be defined throughout the description of the present invention.

Hereinafter, the embodiments of the present invention will be described in detail with reference to the accompanying drawings.

Drawing is a block diagram of an apparatus for managing a ship network in accordance with an embodiment of the present invention.

As illustrated in the drawing, an apparatus 100 for managing a ship network 10 includes a network receiving unit 110, a traffic analysis unit 120, a profile management unit 130, a switching unit 140, a resource allocation unit 150, a network output unit 160, and an exception handling unit 170.

The network receiving unit 110 receives traffic messages from various marine devices 20 to which switch equipments are connected via a ship network 10 and provides the received traffic messages to the traffic analysis unit 120.

The traffic analysis unit 120 parses the traffic messages received from the network receiving unit 110 to analyze traffic information. The traffic information analyzed by the traffic analysis unit 120 includes identification information of transmitters that send the traffic messages, identification information of receivers that are intended to receive the traffic messages, protocol information of the traffic messages, and type information of the traffic messages. The traffic analysis unit 120 comprehends state information for the individual traffic messages based on the traffic information, compares between traffic information that is previously stored in the profile management unit 130 and the state information for the respective traffic messages to determine whether to reach a threshold value, and performs to forward or drop the traffic messages in accordance with the determination result as to whether to reach the threshold value.

To accomplish it, the traffic analysis unit 120 performs an analysis of data such as the traffic messages and the like that are received through the network receiving unit 110. The traffic analysis unit 120 then parses the input port information of the received traffic messages, MAC (Media Access Control) addresses and TCP/IP (Transmission Control Protocol Internet Protocol) information as well as NMEA (National Marine Electronics Association) sentence information, application message information that are parsable and the like. Further, the traffic analysis unit 120 then manages network state information and the like for input information and output information to and from the ship network managing apparatus 100 on a basis of the parsed information. When the amount of information that is transmitted and received is above the threshold value that is defined in the profile management unit 130, the network state information is informed of the exception handling unit 170. Also, when the amount of information, i.e., a traffic message, which is transmitted and received, is above a threshold value that is defined in the profile management unit 130, the received traffic message is dropped. Moreover, when the amount of the traffic message is within the threshold value of a normal range, the traffic message is forwarded to its destination via the switching unit 140. In addition, the traffic analysis unit 120 has a functionality of providing information on the analyzed traffic message if requested from an outside. Besides that, the traffic analysis unit 120 ascertains information about an addition or extinction of a traffic stream that is newly generated or that is in existence and an addition or extinction of a marine device 20 that is newly installed or is in existence and notifies the exception handling unit 170 or the profile management unit 130 of information about the addition or extinction.

The profile management unit 130 stores and manages profiles that include information on the characteristics of the traffic messages received from the switch equipments in the ship network 10 through the network receiving unit 110. Specifically, the profile management unit 130 stores and manages the profiles that include information about the marine devices 20 that are needed to connect to the switch equipments and service information intended to be served by the respective the marine devices 20. In the profile management unit 130, the profiles may be managed by the transmitter to transmit the traffic messages, the receiver to receive the traffic messages, or the service information. In addition, the profile management unit 130 configures the profiles pursuant to the traffic information that has been analyzed for a certain period of time, creates profiles in accordance with inputs provided from a user or external inputs and manages the profiles.

To accomplish it, the profile management unit 130 stores information on the characteristics of the traffic messages received from the switch equipments in the ships. For example, the profile management unit 130 stores information on the marine devices 20 that are needed to connect to the switch equipments and service information generated from the respective marine devices 20 and manages such information. Here, the information on the marine devices 20 may include MAC addresses, IP addresses, IDs of NMEA talkers and the like, and the service information may include information on a total amount of traffics generated from a particular marine device, information on an amount of communications between particular marine devices, information on an amount of communication of a particular application service generated from a particular marine device, information on NMEA sentence information generated or received from a particular marine device and the like. The profile management unit 130 may autonomously store the information on the basis of the amount of traffics generated for a certain period of time in the past that has been analyzed by the traffic analysis unit 120 or store profile information about the traffic messages that will be normally serviced in the respective switch equipments for the management thereof in compliance with inputs from a user or an outside and manages such information.

The resource allocation unit 150 allocates network resources to ports as they need in line with the profiles that are stored in the profile management unit 130. In this case, the allocation of the network resources may be made in compliance with user's inputs or external inputs in addition to the profiles.

As set forth above, the resource allocation unit 150 is in charge of allocating a fixed amount of the network resources to the ports of the switch equipments on the basis of the profile information about the ships. Consequently, particular traffic messages are allowed to be protected from other unauthorized traffics. The resource allocation unit 150 may autonomously allocate necessary network resources in association with the profile management unit 130 or network resources for the respective traffic messages through an interface to the outside.

The network output unit 160 sends data corresponding to the traffic message to the ports to which the network resources are allocated from the resource allocation unit 150 via the ship network 10.

The exception handling unit 170 performs an exception handling registration or deregistration function and an announcement function at exceptional situations. Specifically, the exception processing unit 170 registers and deregisters information on the conditions of the exceptional situations and information on exclusive announcement devices, records and stores the registered information in the traffic analysis unit 120, receives event information that has been defined already from the traffic analysis unit 120, and notifies an occurrence of the exceptional situations of the corresponding announcement devices when occurring the exceptional situations.

To accomplish it, the exception processing unit 170 performs the exception handling registration and deregistration function along with the announcement function to notify the exceptional situation. Also, when the traffic analysis unit 120 reports the situation that the network resource allocated to a particular traffic message exceeds a threshold value in the amount of information or there is an unidentified traffic message, the exception processing unit 170 notifies a fixed marine device or a calling marine device of the event information about the situation. Consequently, the exception processing unit 170 aids to prevent a dangerous situation causing a problem to a stability of the ship network 10 from happening by performing the announcement of the dangerous situation.

While the invention has been shown and described with respect to the embodiments, the present invention is not limited thereto. It will be understood by those skilled in the art that various changes and modifications may be made without departing from the scope of the invention as defined in the following claims.

What is claimed is:

1. An apparatus for managing a ship network, the apparatus comprising:
a network receiving unit configured to receive traffic messages through the ship network from marine devices;
a traffic analysis unit configured to parse the traffic messages being received to analyze traffic information;
a profile management unit configured to profiles that include information on the characteristics of the traffic messages received through the network receiving unit;
a switching unit configured to switch the traffic messages to their corresponding ports in accordance with destinations of the traffic messages;
a resource allocation unit configured to allocate network resources to the ports as needed in compliance with the profiles; and
a network output unit configured to send data corresponding to the traffic messages through the ports and the ship network.

2. The apparatus of claim 1, wherein the traffic information analyzed by the traffic analysis unit comprises identification information of transmitters for sending the traffic messages, identification information of receivers for receiving the traffic messages, protocol information of the traffic messages and type information of the traffic messages.

3. The apparatus of claim 1, wherein the traffic analysis unit is configured to:
comprehend state information on the respective traffic messages that are identified on a basis of the traffic information;
compare the traffic information, which is included in the profiles, that is previously stored in the profile management unit and the comprehended state information to determine whether to reach a threshold value; and
perform a forwarding or drop the traffic messages depending on the determination result as to whether to reach the threshold value.

4. The apparatus of claim 1, wherein the profile management unit is configured to store and manage the profiles that include information about the marine devices and service information to be served in the respective marine devices.

5. The apparatus of claim 4, wherein the profile management unit is configured to manage the profiles by the transmitters for sending the traffic messages, the receivers for receiving the traffic messages, or the service information.

6. The apparatus of claim 5, wherein the profile management unit is configured to:
configure the profiles pursuant to the traffic information that has been analyzed for a certain period of time through the traffic analysis unit; and
create the profiles in accordance with inputs provided from a user or external inputs to manage the profiles.

7. The apparatus of claim 1, wherein the resource allocation unit is configured to allocate the network resources on the basis of the profile information, a user's input or an external input.

8. The apparatus of claim 1, further comprising an exception handling unit configured to perform an exception handling registration or deregistration function and an announcement function.

9. The apparatus of claim 8, wherein exception handling unit is configured to:
register and deregister information on conditions of an exceptional situation and information on announcement devices;
record the registered information in the traffic analysis unit for the storage thereof;
receive event information that has been defined already from the traffic analysis unit; and
notify an occurrence of the exceptional situations of the corresponding announcement devices when occurring the exceptional situations.
